(19) United States
(12) Patent Application Publication
(10) Pub. No.: US 2014/0352509 A1
(43) Pub. Date: Dec. 4, 2014

(54) COUNTER-DIE APPARATUS

(71) Applicant: Michigan Lasercut, Kentwood, MI (US)

(72) Inventor: Steven Schroder, Grand Rapids, MI (US)

(73) Assignee: Michigan Lasercut, Kentwood, MI (US)

(21) Appl. No.: 14/283,787

(22) Filed: May 21, 2014

Related U.S. Application Data
(60) Provisional application No. 61/827,946, filed on May 28, 2013.

(51) Int. Cl. B31B 1/16; B26D 7/08

(52) U.S. Cl. CPC B31B 1/16; B26D 7/08
USPC 83/25; 493/74; 493/334

(57) ABSTRACT

A counter-die apparatus includes a plurality of recesses disposed thereon, wherein the recesses are adapted to be disposed and aligned with blades of a cutting die, such that the recesses create uncut portions on an underside of a paperboard material as cut by a cutting die in a die converting process.

### CROSS-REFERENCE TO RELATED APPLICATION

This application claims the benefit under 35 USC §119(3) of U.S. Provisional Application No. 61/827,946, filed May 28, 2013, entitled COUNTER-DIE APPARATUS, the entire contents of which are incorporated herein by reference.

### FIELD OF THE INVENTION

The present invention generally relates to a counter-die assembly, and more particularly, to a counter-die assembly having a plurality of recesses disposed therein for providing a bond between a blank and scrap material in a die converting process.

### BACKGROUND OF THE INVENTION

In the die converting or die cutting industry, die cutting machines are used to stamp sheets of material according to a predefined pattern to create a blank. Generally, a cutting die and a counter-die cooperate to cut and crease a sheet of a substrate to provide a blank. The cutting die typically includes cutting blades and rulings which protrude from a supporting plate. The supporting plate is generally made of wood, plywood or synthetic materials. The blades and rulings are arranged according to a predefined pattern and extended outwardly from the supporting plate in a vertical manner with respect to the substrate which is positioned on the counter-die, sometimes referred to as the female die, in the die converting apparatus. When a blank is stamped from a sheet material, it is generally necessary for the blank to remain connected to the scrap or waste material from which the blank was cut to increase the ease of handling the entirety of the sheet material through a completed die converting process. During the manufacturing of greeting cards, for instance, multiple card designs may be printed on large sheets of card stock. Using a die cutting process, the individual cards are cut from the large sheet of card stock. In this process, the individual cards are generally retained in the large sheet by small pieces of uncut paper called “nicks”. Thus, instead of the blades of the cutting die completely penetrating through the card stock substrate, the cutting die may, at a few points along a cut line, leave portions of the substrate uncut or only cut partway through the card stock substrate. These uncut portions are typically very small portions adapted to keep the blank and surrounding waste portions coupled together during processing and handling in the die converting process.

Nicks are commonly created along a blade disposed in the cutting die by a manufacturer grinding portions of the blade, such that the blade does not cut continuously through a substrate. In this way, the blade will have small portions, which will not cut a paper sheet material as the cutting die contacts the counter-die. Thus, a nick is formed in such a cut line, thereby binding the blank to the surrounding waste substrate. In an exemplary form, a cutting die may be prepared and the cutting die manufacturer may remove material from the blade thereby making interruptions in the cutting edge of the blade. Such portions, once formed, will not cut fully through a paperboard substrate. Using this method, a blank is created having a plurality of nicks disposed along the upper surface of a paperboard substrate. When the blank is removed from the surrounding waste area, these nicks remain on the blank, and are detectable by consumers on cartons or packages used in commerce. The nicks create an unsightly and uneven cut line on the packaging which is undesirable. Further, if the paperboard substrate is a coated paperboard substrate, the nick, which is formed on the coated side of the paperboard substrate, is even more noticeable as the coating rigidifies the paperboard substrate and thereby rigidifies the nick, making the nick more pronounced and noticeable.

Thus, it is desirable to provide a counter-die for a die converting process from which a blank can be prepared that appears to have no nicks, or is “nickless”, to the consumer.

### BRIEF SUMMARY OF THE INVENTION

One aspect of the present invention includes a counter-die having one or more recesses disposed thereon, wherein the recesses align with and cooperate with a blade disposed on a cutting die, such that the bringing together of the cutting die and the counter-die provides a cut line which is non-continuous or interrupted at the recessed locations of the counter-die.

Yet another aspect of the present invention includes a method for providing a bond between a blank and a surrounding waste material on a substrate in a die converting process, wherein the method includes the steps of providing a cutting die having one or more blades, providing a counter-die adapted to align with and cooperate with the cutting die to cut a blank from a sheet material, and providing one or more recesses disposed on the counter-die which are adapted to align with the blades of the cutting die, such that the recesses of the counter-die are disposed along cut lines to be made in the sheet material.

Yet another aspect of the present invention includes a counter-die for use with a die cutting apparatus. The die cutting apparatus includes upper and lower platens, wherein the upper platen has a cutting die affixed thereto with cutting blades and rulings extending outwardly therefrom towards the lower platen. The counter-die is positioned on and supported by the lower platen. In use, the upper and lower platens cooperate to covert a planar substrate into blank and waste sections in a die converting process. The counter-die includes a generally planar body portion having an upper cutting surface with a plurality of cutting lines and creasing channels disposed thereon. The cutting lines and creasing channels are configured to align with the cutting blades and rulings of the cutting die respectively. A plurality of recesses are disposed on and extend into the generally planar body portion of the counter-die. The recesses are disposed at various locations along the cutting lines, and define relief portions on the cutting surface of the counter-die, such that the cutting blades will partially cut the planar substrate at the plurality of recesses, thereby keeping the waste sections connected to the blank sections in the die converting process.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a fragmentary cross-sectional view of a cutting die and a counter-die for cutting a blank as found in the prior art;

FIG. 2 is a top plan view of a counter-die of the present invention disposed and supported on a lower platen;

FIG. 3 is a fragmentary cross-sectional view of a cutting die and counter-die of the present invention showing relative movement of the cutting die in a die converting process;

FIG. 4 is a fragmentary cross-sectional view of the cutting die and counter-die of FIG. 3, indicating relative movement of the cutting die in a die converting process;

FIG. 5 is a fragmentary cross-sectional view taken at location V of FIG. 4; and

FIG. 6 is a perspective view of a sheet material as cut in a die converting process.

### DETAILED DESCRIPTION OF THE PREFERRED EMBODIMENTS

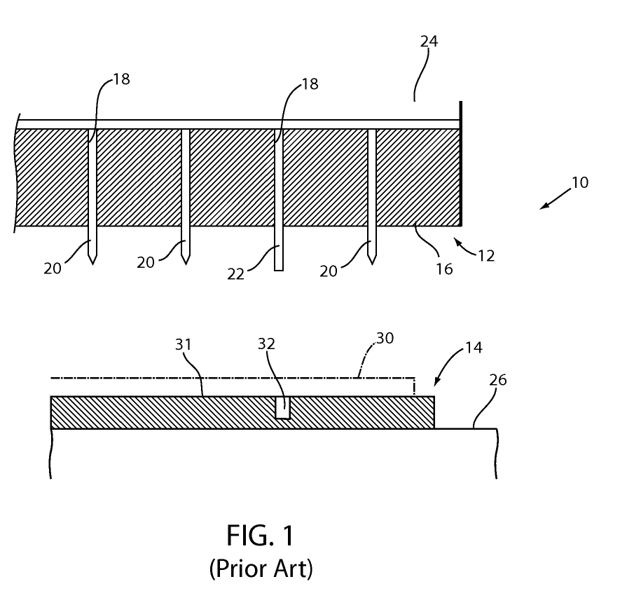

For the purposes of description herein, the terms “upper,” “lower,” “right,” “left,” “rear,” “front,” “vertical,” “horizontal,” “top,” “bottom” and derivates thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification, are simply exemplary embodiments. Hence, specific dimensions and other physical characteristics relating to the embodiments disclosed herein are not to be construed as limiting, unless expressly stated otherwise. Further, it is noted that the die converting process is a suitable process for a variety of substrates including, but not limited to, solid bleached sulfate (SBS), solid unbleached sulfate (SUS), clay coated news back, Mylar, polyethylene terephthalate (PET), amorphous polyethylene terephthalate (APET), polyvinyl chloride (PVC), and plastic. Several of these materials may be comprised of virgin or recycled materials. For purposes of the present disclosure, the term “paperboard” will be used throughout as the exemplary substrate used with the present invention.

Referring now to FIG. 1, a cross section of a cutting die apparatus of the prior art is shown. The die cutting apparatus 10 includes a cutting die 12 and a counter-die 14. The cutting die 12 includes a base plate 16 which may be a plywood base plate, wherein the base plate 16 includes one or more channels 18 disposed therein. The channels 18 are adapted to receive cutting blades 20 or rulings 22, wherein the cutting blades 20 are adapted to cut a paperboard substrate. The rulings 22 are adapted to crease a paperboard substrate, such as paperboard substrate 30 disposed on the counter-die 14. The cutting die 12 is formed such that the blades 20 and rulings 22 are fixed in place on the base plate 16. In this way, the cutting die 12 is adapted to cut blanks from the paperboard 30 in a repeatable manner. In assembly, the cutting die 12 is supported in the die cutting apparatus 10 on an upper platen 24.

As further shown in FIG. 1, the counter-die 14 is supported on a lower platen 26 and has a paperboard material 30 disposed thereon. The counter-die 14 includes a cutting surface 31 and one or more channels 32 disposed therein, wherein the channels 32 align and correspond to the rulings 22 disposed on the cutting die 12. In use, the blades 20 will cut through the paperboard 30 as the upper platen 24 is configured to bring the blades 20 into contact with the cutting surface 31 of the counter-die 14 without damaging the blades 20. Conversely, the rulings 22 will crease the paperboard 30 in the die converting process.

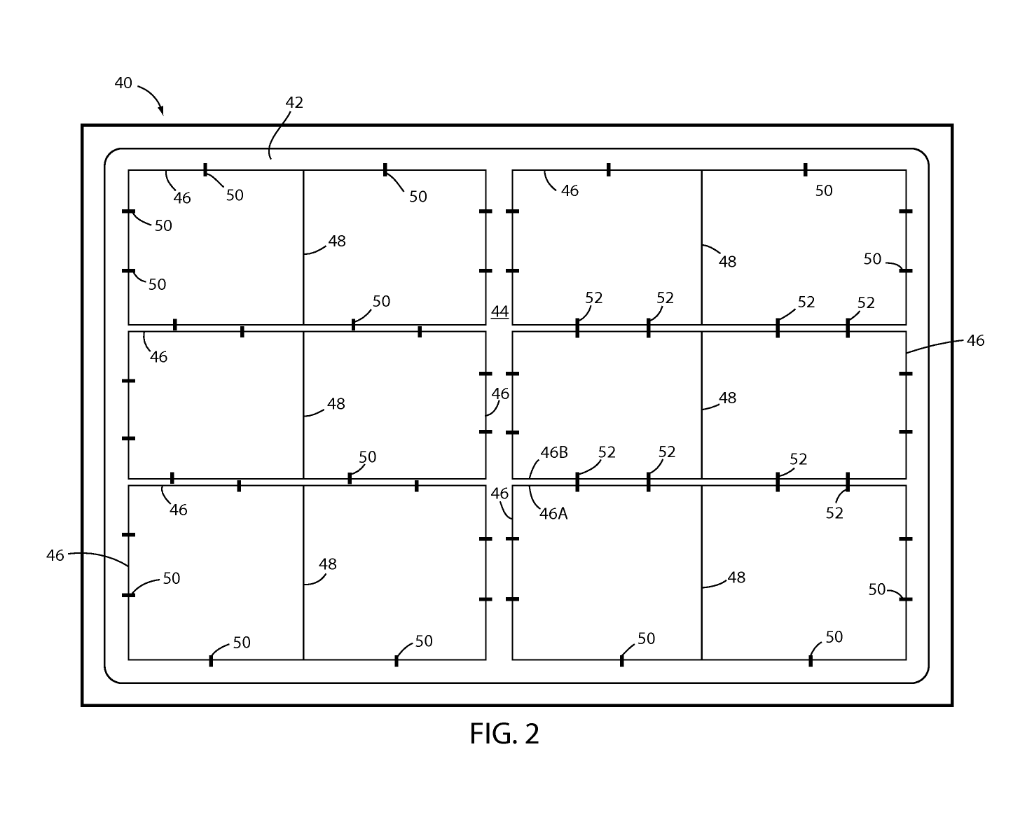

Referring now to FIG. 2, a lower platen 40 is shown having a counter-die apparatus 42 of the present invention positioned and supported thereon. The counter-die apparatus 42 may be made from a variety of materials including, but not limited to, a metallic material, such as stainless steel. The counter-die 42 can be made to have any material thickness necessary for a particular job. As shown in FIG. 2, the counter-die 42 includes a generally planar body portion in the form of a plate with an upper cutting surface 44 on which a paperboard substrate is situated. In the embodiment shown in FIG. 2, the counter-die apparatus 42 is adapted to be positioned below a cutting die, wherein the cutting die is adapted to cut six card blanks having a crease formed thereon. As used with the counter-die 42 shown in FIG. 2, the cutting die will include a series of blades adapted to cut a paper substrate along cutting lines 46 disposed on the cutting surface 44 of the counter-die 42. The cutting die will also include rulings which are adapted to crease the blanks produced from the paperboard along creasing grooves 48 shown in FIG. 2. The creasing grooves 48 may be milled into the counter-die 42. As further shown in FIG. 2, a plurality of recesses 50 are positioned along the cutting lines 46 at various locations and are, in this embodiment, substantially perpendicular to the associated cutting lines 46. The recesses 50 extend into a material thickness of the generally planar body portion 43 of counter-die 42 to create a void or relief on the cutting surface 44 of the counter-die 42. The recesses 50 are generally perpendicular to the cutting lines 46, and thereby provide a void necessary to keep a paperboard sheet together during the die converting process. The recesses 50 are created on the cutting surface 44 of the counter-die 42 by a recess forming process such as milling. A micro-milling cutter used on a computer numeric control (CNC) machine can directly form the recesses 50 in the counter-die 42. The depth of the recesses 50 will generally correspond to the paperboard material being converted in the die converting process. Generally, the recesses will have a depth that is slightly more than the thickness of the paperboard being cut. For example, when using an SBS substrate that is 0.014 inches thick, the corresponding recesses disposed below the SBS material could be 0.016 inches. The milling process can be coordinated with a CAD program adapted to design the cutting die for any particular job. In this way, the milling of the recesses 50 can be computer aided to ensure precision placement along a cutting line, such as cutting lines 46. As further shown in FIG. 2, recesses 52 are positioned on adjacent cutting lines 46A and 46B, such that the recesses 52 create a void in both cutting lines 46A and 46B, thereby keeping the blanks coupled to the scrap or waste paperboard during the die converting process as further described below.

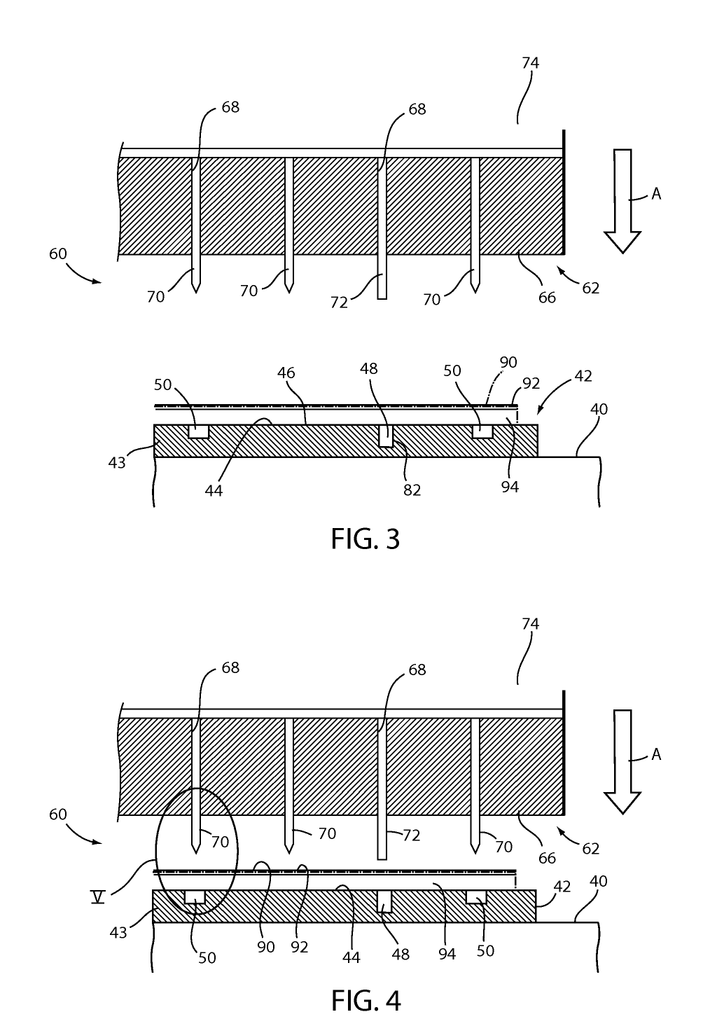

Referring now to FIG. 3, die cutting apparatus 60 is shown having a cutting die 62 as used with counter-die apparatus 42. The cutting die 62 includes a base plate 66 having a plurality of channels 68 disposed therein. In assembly, the base plate 66 is adapted to have cutting blades 70 and rulings 72 disposed in the channels 68 for fixedly mounting the blades 70 and crease rulings 72 to the cutting die 62. The cutting die 62 is mounted to an upper platen 74 in the die cutting apparatus 60, such that the blades 70 and crease rulings 72 extend outwardly from the cutting die 62 towards a lower platen 40. As further shown in FIG. 3, the counter-die 42 is supported on the lower platen 40, and includes creasing channels 82 similar to creasing lines 48 shown in FIG. 2. Recesses 50 are shown disposed on the cutting surface 44 of the counter-die 42. Cutting lines 46 are adapted to align with the blades 70 of the cutting die 62, and in the embodiment shown in FIG. 3, recesses 50 are also adapted to align with blades 70 for creating a bonded portion or nick in the paperboard substrate 90. The blades 70 and crease rulings 72 of the cutting die 62 contact the paperboard substrate 90 as the cutting die 62 moves downward in a die converting process as indicated by arrow A, such that the upper and lower platens 74, 40 cooperate to convert the paperboard substrate 90 in the die cutting apparatus 60.

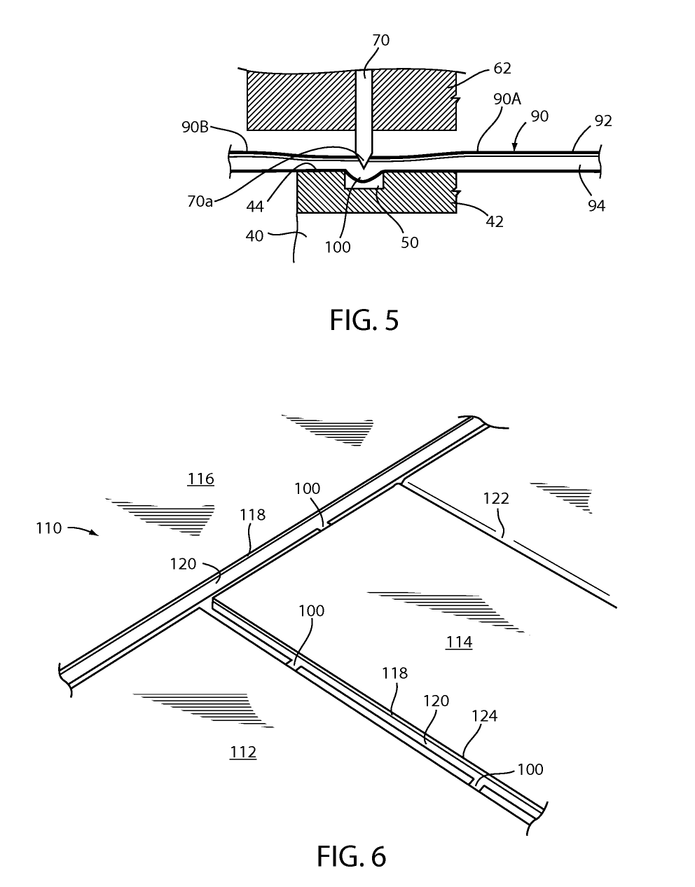

The paperboard material 90 shown in FIGS. 3-5 includes a coating layer 92 and a backing layer 94. The coating 92 may include a wax coating having a thickness from 0.05 to 0.1 mm disposed on an upper surface of the backing layer 94. A variety of polymer coatings may be suitable for use on the coating 92 of the paperboard substrate 90. In assembly, the coating 92 provides structural rigidity to the paperboard substrate 90 and also provide a smooth finished upper surface to the paperboard 90. As shown in FIG. 3, the backing layer 94 is disposed directly on the counter-die 42 and the coating layer 92 is positioned such that this coating layer 92 is the first portion of the paperboard substrate 90 to contact the blades or rulings 70, 72 of the cutting die 62 in the die converting process as best shown in FIGS. 4 and 5.

Referring now to FIG. 4, the cutting die 62 has moved in a direction as indicated by arrow A towards the counter-die 42 and the paperboard substrate 90. Referring now to FIG. 5, blade 70 has a tip portion 70a which has cut through the upper coating layer 92 of the paperboard substrate 90 and partially cut through the backing layer 94 of the paperboard substrate 90. As blade 70 is aligned in FIG. 5 with a recess 50 disposed in the counter-die 42, the blade 70 will not, at this location, come into full contact with the cutting surface 44 of the counter-die 42. The tip portion 70a of blade 70 does not cross the plane of the cutting surface 44 to extend into recess 50. Thus, a portion of bonded material of the backing layer 94, indicated at reference numeral 100, is provided to keep a blank portion 90A of the paperboard 90 connected or coupled to a waste or scrap portion 90B of the paperboard substrate 90 during the die converting process. Thus, the bonded portion 100 forms a bridge of connective fiber between the blank portion 90A and the waste or scrap portion 90B of the paperboard substrate 90. In accordance with the present invention, this connective fiber bridge 100 is a coupling defined on the underside or backing layer 94 of the paperboard substrate 90. In this way, the blank portion 90A is created having a smooth and continuous cut edge formed along the coating layer portion 92 of the paperboard substrate 90. As noted above, the coating layer 92 is a rigidified layer, such that when a nick is created in this layer using the nicking process of the prior art, a more pronounced nick is formed as compared to the bridged fibers of bonded portion 100 left in contact on the underside or backing layer 94 of the paperboard substrate 90 by the counter-die 42 of the present invention. In the exemplary embodiment, using a paperboard substrate 90, the connective bridges or bonded portions 100 are formed from fibrous connections coupling the blank portion 90A of the paperboard substrate 90 to the scrap portion 90B. The indication that the connective bridges or bonded portions 100 are formed from connective fibers is exemplary only and not meant to limit the spirit of the invention. One of ordinary skill in the art will understand that the connective bridges or bonded portions 100 defined in the backing layer 94 of the paperboard substrate 90 will be comprised of the same material used to manufacture the backing layer 94 of the paperboard substrate 90. Thus, if a homogenous plastic substrate is used, the connective bridges will comprise polymeric connective bridges.

Referring now to FIG. 6, a paperboard substrate 110 is shown having been converted using a die cutting apparatus having a counter-die, much like counter-die 42 shown in FIG. 2, to produce blanks 112, 114 and waste or scrap sections 116. The paperboard substrate 110 includes a coating layer 118 disposed on top of a backing layer 120. As shown in FIG. 6, connective fiber bridges 100 are formed between the serially aligned blanks 112, 114 as well as the waste portion 116 of the paperboard 110. A creased line 122 is also shown on blank 114 such that blank 114 will be a foldable blank at creased line 122 in assembly. As shown in FIG. 6, the edges 124 created on the coating layer 118 of the paperboard substrate 110 are continuous, uninterrupted and smooth, thereby providing blanks 112, 114 that are more ascetically pleasing for use in card, or carton making or other die cutting applications (i.e. plant tags, medical devices, etc.). Further, having the connective fiber bridges 100 disposed in the backing layer 120, the blanks 112, 114 are easily separated from the waste material 116 and are further easily separated from one another in a final die converting phase. Further, a blank, such as blanks 112, 114 shown in FIG. 6, having a perceived “nickless” appearance is also more efficiently run on other processing equipment, such as folding and gluing machines.

The connective fiber bridges 100 created by the recesses 50 (FIG. 2) of the counter 42 of the present invention allow for a unitary paperboard substrate to move through the die converting process in a connected manner. If a blank is completely cut from the paperboard material and fully separated from the waste or scrap, the blank will become free moving on top of the counter-die and lose the precision necessary to provide a satisfactory blank. The counter-die of the present invention not only holds the blanks and waste paper together using connected fiber bridges 100, but also provides a clean edge 124 on a coating layer 118 of a blank 112, 114 to provide a more pleasing aesthetic look and feel for a paperboard product as compared to a paperboard product converted using the nicking methods currently known. The present invention ensures that all the edges of a blank that are coated are fully cut through the coating layer 118 in the die converting process, while portions of a backing layer 120 are left intact to define bridges 100 for better handling of the paperboard substrate 110.

Thus, the present invention further includes a method of converting a paperboard substrate, such as substrate 90 shown in FIG. 3, wherein the paperboard substrate includes a coating 92 disposed on a backing layer 94. The method includes providing die press 60 with upper platen 74 and lower platen 40. The method further includes providing a cutting die 62 coupled to the upper platen 74 and having blades 70 extending downwardly therefrom. The method further includes providing a counter-die 42 coupled to the lower platen 40 and having on or more recesses 50 extending downwardly from a cutting surface 44 into a body portion 43 of the counter-die 42. The method further includes receiving a paperboard substrate 90 on the counter-die 42, wherein the paperboard substrate 90 is positioned on the counter-die 42 with the coating 92 facing upwards towards the cutting die 62. The method further includes moving either the upper platen 74 or the lower platen 40 towards the other to bring the blades 70 into contact with the paperboard substrate 90, thereby cutting through the coating 92 of the paperboard substrate 94, and partially cutting through the backing layer 94 of the paperboard substrate 90 in areas where the blades 70 are disposed over and aligned with the one or more recesses 50 of the counter-die 42.

It will be understood by one having ordinary skill in the art that construction of the described invention and other components is not limited to any specific material. Other exemplary embodiments of the invention disclosed herein may be formed from a wide variety of materials, unless described otherwise herein.

The invention claimed is:

1. A counter-die for use with a die cutting apparatus, the die cutting apparatus including upper and lower platens, the upper platen having a cutting die affixed thereto with cutting blades and rulings extending outwardly therefrom towards the lower platen, wherein the counter-die is supported on the lower platen and further wherein the upper and lower platens cooperate to covert a planar substrate into blank and waste sections in a die converting process, the counter-die comprising:
a generally planar body portion having an upper cutting surface with a plurality of cutting lines and creasing channels disposed thereon, the cutting lines and creasing channels configured to align with the cutting blades and rulings of the cutting die respectively; and
a plurality of recesses disposed on and extending into the generally planar body portion, the recesses disposed at various locations along the cutting lines, wherein the recesses define relief portions on the cutting surface of the counter-die such that the cutting blades will partially cut the planar substrate at the plurality of recesses, thereby keeping the waste sections connected to the blank sections in the die converting process.

2. The counter-die of claim 1, wherein the generally planar body portion is comprised of stainless steel.

3. The counter-die of claim 1, wherein each recess of the plurality of recesses is substantially perpendicular to the cutting line on which the recess is disposed.

4. The counter-die of claim 1, wherein the planar substrate includes a paperboard substrate.

5. The counter-die of claim 4, wherein the paperboard substrate includes a backing layer and a coating layer disposed thereon.

6. The counter-die of claim 5, wherein the paperboard substrate is positioned on the counter-die with the coating layer upwardly facing the cutting die.

7. The counter-die of claim 6, wherein cutting blades of the cutting die are configured to cut through the coating layer of the paperboard substrate.

8. A method of converting a paperboard substrate in a die converting process, comprising the steps of:
providing a die press having an upper platen and a lower platen;
coupling a cutting die to the upper platen, the cutting die having downwardly extending blades;
coupling a counter-die to the lower platen, the cutting die including a cutting surface with one or more recesses disposed thereon;
receiving a paperboard substrate on the counter-die, the paperboard substrate having a coating disposed on a backing layer of the paperboard substrate, wherein the paperboard substrate is positioned on the counter-die with the coating facing upwards towards the cutting die;
moving one of the upper platen and the lower platen towards the other to bring the blades into contact with the paperboard substrate;
cutting through the coating of the paperboard substrate; and
partially cutting through the backing layer of the paperboard substrate in areas where the blades are disposed over the one or more recesses of the counter-die.
